(19) United States
(12) Patent Application Publication
(10) Pub. No.: US 2020/0374286 A1
(43) Pub. Date: Nov. 26, 2020

(54) REAL TIME SELFIE SYSTEMS AND METHODS FOR AUTOMATING USER IDENTIFY VERIFICATION

(71) Applicant: PAG Financial International LLC, Guaynabo, PR (US)

(72) Inventors: Pavan Agarwal, Cerritos, CA (US); Jonathan Ortiz Rivera, Cerritos, CA (US); Gabriel Albors Sanchez, Cerritos, CA (US)

(73) Assignee: PAG Financial International LLC, Guaynabo, PR (US)

(21) Appl. No.: 16/993,148

(22) Filed: Aug. 13, 2020

Related U.S. Application Data
(63) Continuation-in-part of application No. 15/706,590, filed on Sep. 15, 2017, now abandoned.

(51) Int. Cl. H04L 29/06; G06K 9/00; G06Q 50/00

(52) U.S. Cl. CPC H04L 63/0861; H04L 63/0853; G06Q 50/01; G06K 9/00335; G06K 9/00288

(57) ABSTRACT

According to various embodiments of the disclosed technology, a system and method for validating the identity of an online account user in real time is disclosed. The system may include a processor; a memory attached to the processor; a computer readable medium having instruction embedded therein, the instructions configured to cause the processor to perform the operations of: creating a user profile for an online account for a first user, where the user profile may include a picture of a first user's face; receiving a request from a second user requesting to verify the picture of the first user as being an authentic representation of the first user's face; presenting through a computing device instructions of a specified pose for the first user to pose in a verification photo; and submitting the verification photo of the first user with the specified pose to the second user for verification.

### RELATED APPLICATIONS

This application a continuation-in-part of U.S. patent application Ser. No. 15/706,590, filed on Sep. 15, 2017, the contents of which are incorporated herein by reference in its entirety.

### TECHNICAL FIELD

The disclosed technology relates generally to biometric identification for online security purposes. More specifically, the disclosed technology relates to biometric identification for online security purposes using real time picture verification to confirm the identity of the user.

### BACKGROUND

With the accessibility and mainstream nature of social media, the social media platform has become a convenient and accessible way for people to meet new people and expand their network of friends and personal relationships. While social media allows people to become introduced a wider network of people, the obvious downside is that all first interactions with such people on social media must be initiated online behind electronic screens rather than face-to-face interactions. As such, users must trust and assume that the person represented in his or her profile picture on the social media account is an accurate physical representation of that person in real life.

However, often, the profile picture of a person's social media account is often modified, outdated, or completely false. This phenomenon of deceiving people with faulty profile pictures has led to the coining of the term “catfish,” which is now a common term used to describe such online scenarios where someone fabricates an online identity to deceive others on social media. As a result, there is a need for authenticating social media users or other online users in real time for security and verification purposes.

### BRIEF SUMMARY OF EMBODIMENTS

According to various embodiments of the disclosed technology, a system for validating the identity of an online account user in real time is disclosed. The system may include a processor; a memory attached to the processor; a computer readable medium having instruction embedded therein, the instructions configured to cause the processor to perform the operations of: creating a user profile for an online account for a first user, where the user profile includes a picture of a first user's face; receiving a request from a second user requesting to verify the picture of the first user as being an authentic representation of the first user's face; presenting through a computing device instructions of a specified pose for the first user to pose in a verification photo; and submitting the verification photo of the first user with the specified pose to the second user for verification.

Also disclosed are methods for validating the identity of an online account user in real time. The method may include at least creating a user profile for an online account for a first user, wherein the user profile comprises a picture of a first user's face; receiving a request from a second user requesting to verify the picture of the first user as being an authentic representation of the first user's face; receiving instructions of a specified pose for the first user to pose in a verification photo; and submitting the verification photo of the first user posing as instructed to the second user for verification.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for verifying identity of a user associated with an account, according to an implementation of the disclosure.

FIG. 2 illustrates an example process for verifying user identify associated with an account, according to an implementation of the disclosure.

FIG. 3 is example schematic of likelihood of fake account determination analysis, according to an implementation of the disclosure.

FIG. 4 illustrates an example process for using a machine learning module to perform identify verification, according to an implementation of the disclosure.

FIG. 5 illustrates an example computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only bythe claims and the equivalents thereof.

### DETAILED DESCRIPTION OF THE EMBODIMENTS

Described herein are systems and methods for automating the process of user verification. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

As alluded to above, social media is often used by people pretending to be someone else by using images and information from accounts of others. Commonly, this is done for some illicit purpose and takes advantage of inability to verify identity. That is, is often impossible to spot a fake account, leading the users willingly sharing information and even transferring funds to people whose identity is unknown. While there are services that allow reverse image searches to help verify if particular image is associated with other accounts, such verification requires first recognizing that a user may be posing as someone else. Secondly, such verification is tedious and time consuming and often provides incomplete results.

Embodiments of the disclosed technology provide a tool for automating the process of account verification and identify confirmation. An individual user account or profile may be associated with any various online platforms. For example, platforms may include social media platforms, online gaming platforms, online messaging platforms, and transactional business platforms, such as online banking platforms, e-commerce platforms, and the like.

In some embodiments, the user profile may include personal information associated with the user's identity, such as name, age, gender, birthday, occupation, contact information, educational background, and the like. Personal information may include both public information (e.g., open for viewing to some or all users of the platform) and private information (e.g., information hidden from public view). Additionally, personal information may include a recent or accurate photo of the user to be publicly displayed as the user's profile image, as required by the user platform.

The tool utilizes machine learning models to determine whether a particular user account requires verification based on a particular protocol or threshold. For example, the tool may flag new accounts opened by users without existing connections, or accounts that send communications to users without any common connections or “friends.” Additionally, the tool may identify “suspicious” accounts based on the content of the profile and/or communication. Finally, the tool may use geolocation data and request identify confirmation for users whose devices have been associated with previously unused locations in particular period of time.

In some embodiments, the tool may request identify confirmation from accounts it determines that requires such verification, as alluded to above. For example, the tool may request the user to send images and/or videos depicting the user in a particular pose, performing a particular gesture, and/or with particular facial expressions. Finally, the tool may use machine learning models to determine whether the user submitted image or video meets the request. For example, the tool may use facial recognition algorithms to determine if the user depicted in the verification image is indeed the same user depicted in other available images of the user. Additionally, the tool may confirm that the user depicted in the verification image has not been associated with accounts of other users and/or platforms. In yet other embodiments, the tool may request to verify identity through images or videos that include poses or gestures which have not been previously identified among user's images.

### System

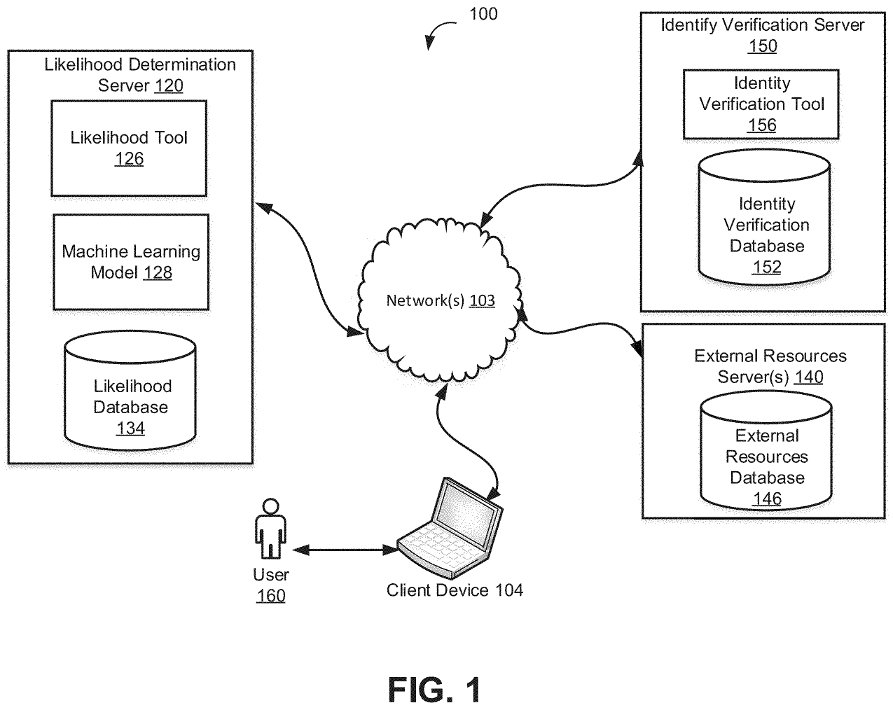

FIG. 1 illustrates an automated user identity verification system 100 according to some embodiments of the disclosed technology. In some embodiments, system 100 may include a likelihood determination server 120, an identity verification server 150, a one or more external resources server(s) 140, a network 103, and a user computing device 104 associated with a user (e.g., a social media user 160). Additionally, system 100 may include other network devices such as one or more routers and/or switches.

In some embodiments, computing device 104 may include a variety of electronic computing devices, for example, a smartphone, a tablet, a laptop, a display, a mobile phone, a computer wearable device, such as smart glasses, or any other head mounted display device, or a combination of any two or more of these data processing devices, and/or other devices.

### Likelihood of False Account Determination and Identify Verification Servers

In some embodiments, likelihood determination server 120 and identity verification server 150 may each include a processor, a memory, and network communication capabilities. In some embodiments, likelihood determination server 120 and identity verification server 150 may each be a hardware server. In some implementations, likelihood determination server 120 and identity verification server 150 may each be provided in a virtualized environment, e.g., likelihood determination server 120 and/or identity verification server 150 may be a virtual machine that is executed on a hardware server that may include one or more other virtual machines. Additionally, in one or more embodiments of this technology, virtual machine(s) running on likelihood determination server 120 and/or identity verification server 150 may be managed or supervised by a hypervisor. Likelihood determination server 120 and identity verification server 150 may be communicatively coupled to network 103.

In some embodiments, the memory of likelihood determination server 120 may include likelihood database 134. The likelihood database 134 may include one or more database, which may store association data related to determining the likelihood of use profile being falsified (e.g., profile information, including biographical information, location information, such as previously visited locations, connections or friends associated with the user, communications sent to other user contacts, communications public ally shared, other accounts linked to the user).

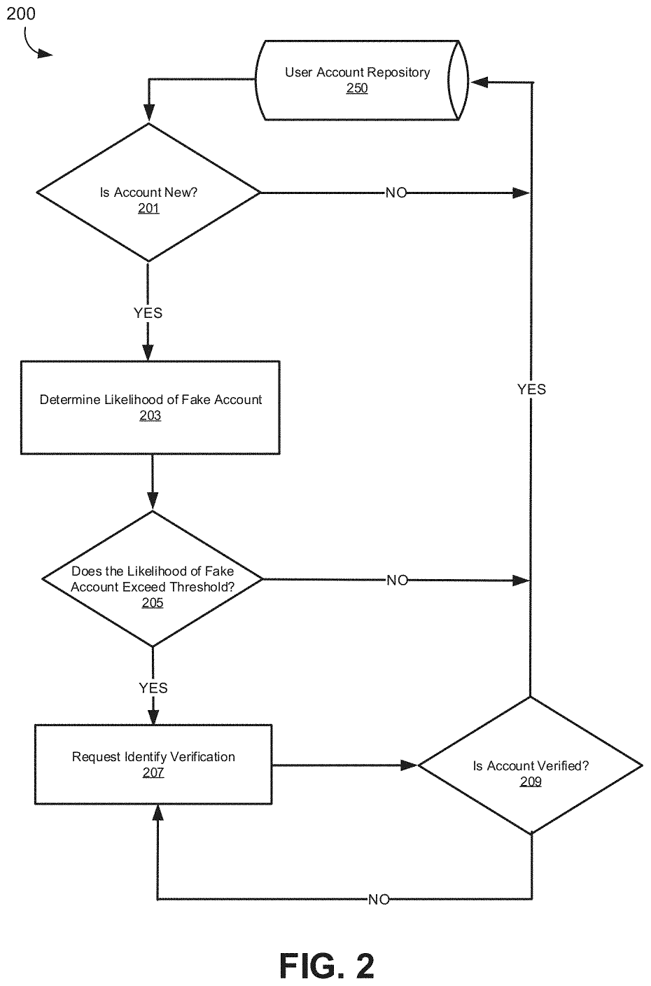

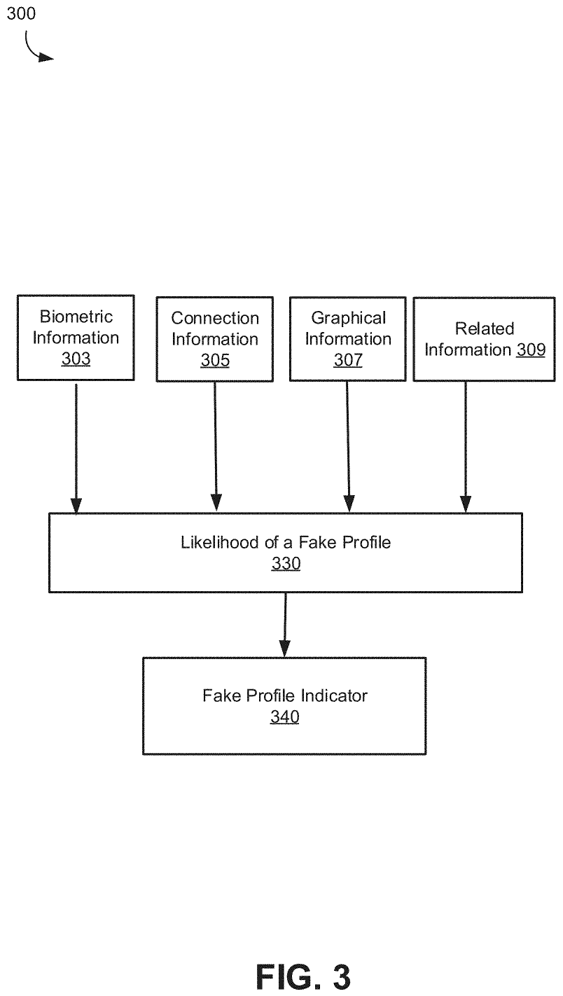

In some embodiments, the memory of likelihood determination server 120 may store application(s) that can include executable instructions that, when executed by likelihood determination server 120, cause likelihood determination server 120 to perform actions or other operations as described and illustrated below with reference to FIGS. 2-3. For example, likelihood determination server 120 may include a likelihood tool 126 configured to determine whether the identity of a user associated with an account profile requires is likely to be fake and requires verification. In some embodiments, likelihood tool 126 may utilize data stored in likelihood database 134, identify verification database 152, and/or external resources database 146, as will be described in detail below.

In some embodiments, system 100 may employ one or more machine learning models 128, which may execute on likelihood determination server 120.

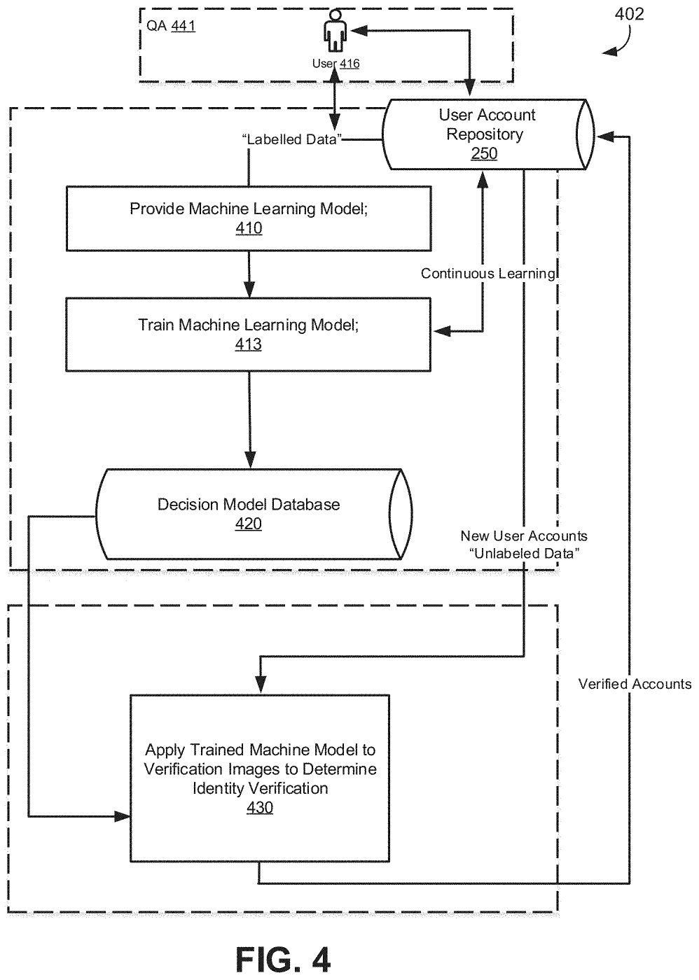

In some embodiments, the memory of identity verification server 150 may store application(s) that can include executable instructions that, when executed by identity verification server 150, cause identity verification server 150 to perform actions or other operations as described and illustrated below with reference to FIGS. 2 and 4. For example, identity verification server 150 may include an identity verification tool 156. For example, identity verification tool 156 may be configured to use one or more verification techniques to confirm that the user in a user account is indeed real and is not using stolen identity. In some embodiments, verification techniques may include using biometric identification (i.e., metrics related to human characteristics). Such human characteristics may include fingerprints, palm veins, facial recognition, retina, body type, body behavior, and the like.

In some embodiments, identity verification tool 156 may include a software module for allowing a user to manually confirm the identity of another account user via biometric identification using real-time submission of photos. For example, identity verification tool 156 may be configured to assist user 160 with verifying identity of another user.

In some embodiments, identity verification database 152 may include one or more databases, which may store data transmitted by users in response to requests to verify identity, data related to results of identity verification performed manually (i.e., machine learning training data), and results of automatic identity verification process, and such similar data.

In some embodiments, likelihood of verification tool 126 and identity verification tool 156, may be each implemented as one or more software packages executing on one or more likelihood determination server 120 and identity verification server 150 computers, respectively. For example, a client application implemented on one or user computing device 104, as client identification verification application.

In some embodiments, likelihood tool 126 and identity verification tool 156 may each be a server application, a server module of a client-server application, or a distributed application. In some embodiments, likelihood tool 126 and identity verification tool 156 may each be implemented using a combination of hardware and software. The application(s) can be implemented as modules, engines, or components of other application(s). Further, the application(s) can be implemented as operating system extensions, module, plugins, or the like.

Even further, the application(s) may be operative locally on the device or in a cloud-based computing environment. The application(s) can be executed within or as virtual machine(s) or virtual server(s) that may be managed in a cloud-based computing environment. Also, the application(s), and even the verification analysis computing devices themselves, may be located in virtual server(s) running in a cloud-based computing environment rather than being tied to one or more specific physical network computing devices. Also, the application(s) may be running in one or more virtual machines (VMs) executing on the mapping and analysis computing devices.

In some embodiments, likelihood determination server 120 and identity verification server 150 may transmit and receive information to and from user computing device 104, one or more external resources servers 140, and/or other servers via network 103. For example, a communication interface of the likelihood determination server 120 and identity verification server 150 may be configured to operatively couple and communicate between likelihood database 134, identity verification database 152, user computing device, and external resources servers 140, which are all coupled together by the communication network(s) 103.

In some embodiments, likelihood tool 126 and identity verification tool 156 may each access likelihood database 134, identity verification database 152, and external resources database 146 over a network 130 such as the Internet, via direct links, and the like.

In some embodiments, likelihood determination server 120 and identity verification server 150 may each be a standalone device or integrated with one or more other devices or apparatuses, such as one or more of the storage devices, for example. For example, likelihood determination server 120 and identity verification server 150 may each include or be hosted by one of the storage devices, and other arrangements are also possible.

### External Resources Server

In some embodiments, external resources servers 140 may be configured to store resource data that includes data related to accounts the user may have on other online platforms. In some embodiments, external resources servers 140 may be configured to communicate with additional disparate third-party services (e.g., public record databases, law enforcement databases, financial, regulatory, and other such similar services) to request and receive data that may be used when determining likelihood of a fake profile.

In some embodiments, external resources server(s) 140 may include any type of computing device that can be used to interface with likelihood determination server 120 and/or likelihood tool 126, likelihood of acceptance databases 134, identity verification database 152, other external resources server(s) 140, and client computing devices 104, 105. For example, external resources servers 140 may include a processor, a memory, and a communication interface, which are coupled together by a bus or other communication link, although other numbers and/or types of network devices could be used. In some embodiments, external resources servers 140 may also include a database (e.g., external resource database 146).

### System Architecture

In some embodiments, likelihood determination server 120, identity verification server 150, external resources servers 140, and or other components may be a single device. Alternatively, a plurality of devices may be used. For example, the plurality of devices associated with external resources servers 140 may be distributed across one or more distinct network computing devices that together comprise one or more external resources servers 140.

In some embodiments, likelihood determination server 120, identity verification server 150, external resources servers 140 may not be limited to a particular configuration. Thus, in some embodiments, likelihood determination server 120, identity verification server 150, external resources servers 140 may contain a plurality of network devices that operate using a master/slave approach, whereby one of the network devices operate to manage and/or otherwise coordinate operations of the other network devices.

Additionally, in some embodiments, likelihood determination server 120, identity verification server 150, external resources servers 140 may comprise different types of data at different locations.

In some embodiments, likelihood determination server 120, external resources servers 140, identity verification server 150 may operate as a plurality of network devices within a cluster architecture, a peer-to-peer architecture, virtual machines, or within a cloud architecture, for example. Thus, the technology disclosed herein is not to be construed as being limited to a single environment and other configurations and architectures are also envisaged.

Although the exemplary system 100 with payor computing device 104, provider device 105, likelihood determination server 120, identity verification server 150, external resources servers 140, and network(s) 103 are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment, such as payor computing device 104, provider device 105, likelihood determination server 120, identity verification server 150, external resources servers 140 may be configured to operate as virtual instances on the same physical machine. In other words, one or more of payor computing device 104, provider device 105, likelihood determination server 120, identity verification server 150, external resources servers 140 may operate on the same physical device rather than as separate devices communicating through communication network(s). Additionally, there may be more or fewer devices than payor computing device 104, provider device 105, likelihood determination server 120, identity verification server 150, and external resources servers 140.

In addition, two or more computing systems or devices can be substituted for any one of the systems or devices, in any example set forth herein. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including, by way of example, wireless networks, cellular networks, PDNs, the Internet, intra nets, and combinations thereof.

### Method

As alluded to earlier, user verification may be performed automatically or manually. In a user-requested verification, a user of a platform may report another user as “suspicious” and request verification. For example, the user may deem another user suspicious upon receiving a friend request or a communication from an unknown user.

During the automatic verification, the system determines whether the identity is likely fake for each new user account created. Upon determining that the identity is likely fake, the system requests verification. By virtue of automatically verifying user identify, the present embodiments ensure a more secure platform. That is, by continuous monitoring of new user accounts allows the system to prevent users with potentially illicit motives from using the platform. Furthermore, by first determining the likelihood of account being fake, the system ensures that users whose accounts are not likely fake are not asked to confirm identify unnecessarily, which potentially may deter users from using the platform. For example, FIG. 2 illustrates a process 200 for determining a likelihood of account being fake according to some embodiments of the disclosed technology.

The process 200 may begin with obtaining user profile or account information associated with a user on a platform from a content database 250 (e.g., a user account repository and database). For example, the user account information may include information associated with a user of a social media platform. In some embodiments, the user account information may include user biographical information, user connection information, and user graphical information.

Biographical information may include information specifying user name, age, contact information (e.g., email address, number), user preferences, likes, interests, and other such information. Connection information may include information specifying information related to other accounts on the platform the user is connected (e.g., friends) as well as other platforms user holds an account with, and so on. The graphical information may include images and/or videos uploaded by the user depicting user likeness.

In step 201, upon receiving user account information, a determination whether the account is newly created may be made. For example, a new account may be an account created within a particular time period (e.g., last 24 hours). Upon determining that the account has not been newly created, the “No” branch is taken and the result is recorded in a field associated with the user profile stored in user account repository 250.

Alternatively, upon determining that the account is newly created, in step 201, a “Yes” branch is take to step 203, where a determination of a likelihood of an account being fake is made. The likelihood of the account being fake or a spoof may reflect the likelihood that the user is misusing someone else's identity. The likelihood of payment acceptance may be determined based on user account information.

Likelihood of Fake Account Determination

For example, likelihood tool 126, illustrated in FIG. 1, may determine a likelihood of a user account being fake or spoofed 330 for a specific user by analyzing information related to the user account. For example, as illustrated in FIG. 3, likelihood of fake account 330 may be determined by analyzing user biometric information 303, user connection information 305, user graphical information 307, and related information 309 obtained by system 100.

For example, biometric information 303 may include user name, age, gender, address, email, phone number, interests, and so on. Connection information 307 specified by the user account information may include information related to other users that the particular user may be affiliated with (i.e., friends). Graphical information 307 specified by the user account may include images and/or videos depicting the user.

Related information 309 may include information related to other accounts associated with the user. Related information 309 may be obtained by system 100 from user account information computing device 105 and/or external resource services 140, as illustrated in FIG. 1, and may include information related to other accounts the user may have created on other platforms. In some embodiments, related information 309 may include public information about the user based on user's biometric information 303. For example, such information may include family information (e.g., marriage records, and other familial information), educational records, employment information, property ownership information, and so on. In yet other embodiments, related information 309 may include information that may negatively affect the user (e.g., criminal records, bankruptcy records, and so on).

Additional information 309 may be obtained from a variety of sources including public records, social media providers, and other sources of related information about the user. For example, additional information may be obtained from one or more of law enforcement databases, sex offender registries, National Crime Information Center's databases, missing persons registries, FBI most wanted fugitive databases, and other such sources.

In some embodiments, system 100 may prioritize or rate the obtained biometric information 303, connection information 305, graphical information 307, and related information 309 based on a number of additional parameters. For example, a number of address associated with the user may be more relevant to a user with a small or non-existent number of connections than a user with a large number of connections.

System 100 may perform likelihood of facke account or profile determination 330 by utilizing a variety of analytical techniques to analyze collected sets of biometric information 303, connection information 305, graphical information 307, and related information 309, obtained from various sources to generate fake profile indicator 340. For example, system 100 may utilize Bayesian-type statistical analysis to determine the fake profile indicator 340. Fake profile indicator 340 may be a quantified likelihood of acceptance of an account being a spoof. That is, a calculated numerical value associated with fake profile indicator reflects a likelihood of the account being used as a spoof or fraud. For example, a lower fake profile indicator may indicate that the account is most likely real.

In some implementations, fake profile indicator 340 may be expressed based on a sliding scale of percentage values (e.g., 10%, 15%, . . . n, where a percentage reflects a likelihood of payment acceptance), as a numerical value (e.g., 1, 2, . . . n, where the magnitude of quantity reflects a likelihood of payment acceptance), or as text (e.g., “very low”, “low”, “medium”, “high”, “very high”), and other similar schemes used to represent fake profile indicator 340.

In some implementations, biometric information 303, connection information 305, graphical information 307, and related information 309 may be analyzed during likelihood of fake profile determination 330 in conjunction with one or more predictive models. The predictive models, may include one or more of neural networks, Bayesian networks (e.g., Hidden Markov models), expert systems, decision trees, collections of decision trees, support vector machines, or other systems known in the art for addressing problems with large numbers of variables. Specific information analyzed during the likelihood of fake account determination may vary depending on the desired functionality of the particular predictive model.

In some embodiments, a dynamic weight may be assigned to each biometric information 303, connection information 305, graphical information 307, and related information 309 when determining the likelihood of fake profile 330.

In some implementations, specificity, relevance, confidence and/or weight may be assigned to at least one of biometric information 303, connection information 305, graphical information 307, and related information 309, based on the relevance and relationship between various data points. The assignment of these weight factors may be used in determination of user-specific profile determination results.

In some embodiments, the system may use one or more thresholds when determining the likelihood of a profile being fake. For example, fake profile indicator 340 determined during the likelihood of a fake profile determination 330 may be compared to a threshold specified by the system. For example, in step 205 illustrated in FIG. 2, a determination whether the fake profile indicator 340 exceeds the threshold is made. If fake profile indicator 340 is below the threshold value, then the “No” branch is taken and the result is recorded in a field associated with the user profile stored in user account repository 250.

Alternatively, if the fake profile indicator 340 is above the threshold value, then the “Yes” branch is taken and system will request the user to verify their identity in step 207.

In some embodiments, individual user may identify one or more thresholds associated with the fake profile determinations as a setting the system will use. For example, accounts associated with users without mutual connections that generate communications (e.g., messages or requests to become friends) may include a lower fake profile indicator threshold. Similarly, accounts that include geolocation information indicating multiple geographic locations from which accounts were accessed may include a lower fake profile indicator threshold.

Referring back to FIG. 2, as alluded to above, in step 207, the above the threshold false profile indicator may be used to request identity verification.

If the user in question accepts the verification request, the account verification system may send a notification with a specific set of pose instructions. This ensures that the user in question is verified by in real time and that the user cannot merely send an old photo in an attempt to deceive others. As such, the user must then take a photo themselves successfully executing these instructed poses and submit them. The account verification system may access the camera already integrated on the mobile or electronic computing device. By accessing the camera, the user may be able to take a selfie through the verification system.

By way of example only, the specific pose instructions may require that the user take a selfie with a specified hand motion, facial expression, body motion or combinations thereof. Such pose instructions may include saluting, waving, making a peace sign, mimicking round eyeglasses by placing rounded hands over each eyes, sticking out the tongue, making a wide rounded “o” shape with the mouth or other shapes, twirling, performing jumping jacks, and the like. The pose instructions may can include any wide range of poses and gestures that that can be recognized by various facial and gesture recognition software installed in the account verification system.

By way of example only, the account verification system may transmit verification instructions which may instruct the user to take an image of themselves (i.e., a verification selfie) within a set time frame of accepting the verification request and the set of pose instructions. By doing so, this may allow real-time verification of the user's online account. Once the user has taken the selfie with the instructed pose, the account verification system may validate the identity of the account user. In some embodiments, the account verification system may validate only the user's facial feature while in other embodiments, the account verification system may validate only the satisfaction of the pose requirements. In other instances, the account verification system may require that the system confirms both the user's facial features and instructional poses before validating the user's account.

### Identity Verification

FIG. 4 illustrates example process of validating user identity according to an implementation of the disclosure using a machine learning model. Other artificial intelligence techniques may be used instead of, or in addition to, using a machine learning model. By virtue of utilizing a machine learning approach enhances the automated validation process described herein. In particular, by using machine learning model, allows the system to determine if the image is real and/or if it belongs to another user as well as confirm if the identity validation requirements have been satisfied.

The process 404 may include applying a machine learning model, at 410. The machine learning model may be any machine learning mode, algorithm, or an Artificial Intelligence (AI) technique, capable of the functions described herein. The process 402 may include training the machine learning model, at 413. For example, verification images including specific facial features, gestures, poses, and actions of the users along with information included in the verification request and/or other data elements, for the previously verified users (i.e., users whose verification images correspond to verification instructions) may be applied as inputs to the machine learning model. Training the machine learning model may include supervised learning, unsupervised learning, or combinations thereof. During the training stage, process 402 may include the machine learning model storing the values related to the decisions made during the training stage in a decision model database 420.

After training, the machine learning model may be used to validate “unlabeled” data, i.e., any verification image transmitted by the user. The machine learning model may utilize the decision data values that are determined to be related to data in the verification image from decision model database 420 when determining identity confirmation, at 430. For example, the machine learning model may identify facial features and gestures in the verification images and determine if matches exist between the values stored in decision model database 420 when making the identity confirmation determination. Depending on match reliability, the machine learning model may create accurate verification for unlabeled repair documents.

In other embodiments, facial recognition algorithms may be used in step 410 to verify whether the person depicted in the verification image may be identified as the user depicted in the images and/or videos specified by the graphical information associated with the user account.

In yet other embodiments, facial recognition algorithms may be used in step 410 to verify whether the person depicted in the verification image may be associated with any other user. In other words, the system may determine if the verification image includes information obtained from another source. For example, the system may obtain images of users from other platforms accessed through external resource services 140, illustrated in FIG. 1, to determine whether the person in the verification image is associated with another profile. Furthermore, the system may use biographical information (e.g., user name, age, gender, and so on) as a secondary layer of verification. That is, if the person in the verification image matches the person depicted in an image in another platform, the name of that user may be used to verify the identity of the user (i.e., if the names are the same then it is likely that the user simply has another account rather than using someone else's identity).

In some embodiments, user whose identity is being verified may disagree with identity verification determinations generated by process 402. In those cases, the quality assurance process 441 may request another user (e.g., friend user 216) to confirm the identity of the user that is being verified. Upon receiving this third-party confirmation, the rejected the identity verification may in turn be fed back to the model for further relearning and as re-tuning the machine learning model for enhanced accuracy of future predictions. The relearned model may then be redeployed and utilized again to update and complete the identity verification process with enhanced precision.

Referring back to FIG. 2, in step 209, a determination whether user identity is verified, as illustrated in FIG. 4, may be made. Upon determining that the verification image does not provide sufficient verification, the “No” branch is taken back to step 207, where a new request to verify identity may be generated, as described earlier.

Alternatively, upon determining that the verification image provides sufficient verification, the “Yes” branch is taken and the result is recorded in a field associated with the user profile stored in user account repository 250.

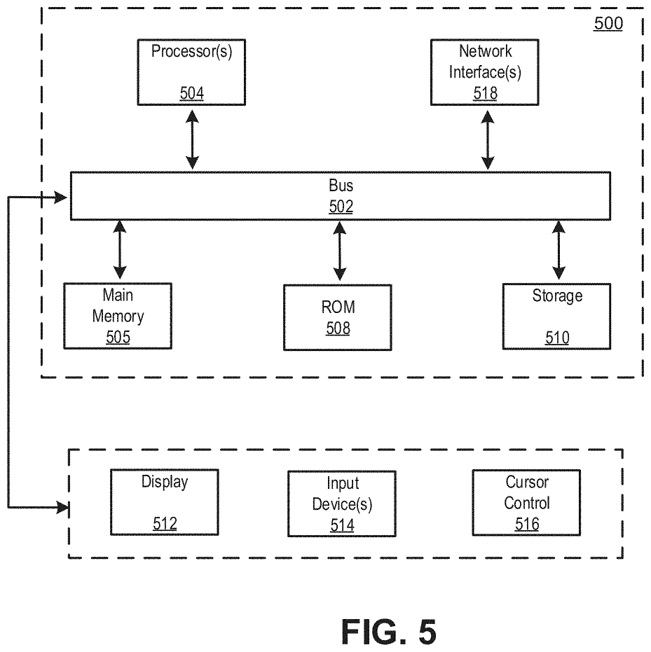

### System

Where circuits are implemented in whole or in part using software, in one embodiment, these software elements can be implemented to operate with a computing or processing system capable of carrying out the functionality described with respect thereto. One such example computing system is shown in FIG. 5. Various embodiments are described in terms of this example-computing system 500. After reading this description, it will become apparent to a person skilled in the relevant art how to implement the technology using other computing systems or architectures.

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors and/or specialized graphical processors.

The computer system 500 also includes a main memory 505, such as a random access memory (RAM), cache and/or other dynamic storage devices, coupled to bus 502 for storing information and instructions to be executed by processor 504. Main memory 505 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such a SSD, magnetic disk, optical disk, or USB thumb drive (Flash drive), etc., is provided and coupled to bus 502 for storing information and instructions.

The computer system 500 may be coupled via bus 502 to a display 512, such as a transparent heads-up display (HUD) or an optical head-mounted display (OHMD), for displaying information to a computer user. An input device 514, including a microphone, is coupled to bus 502 for communicating information and command selections to processor 504. An output device 516, including a speaker, is coupled to bus 502 for communicating instructions and messages to processor 504.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, boy Java, Java, C or C++. A software component may be compiled and linked into an executable program, installed in a dynamic link library, or may be written in an interpreted programming language such as, for example, BASIC, Perl, or Python. Components may also be written in a database language such as SQL and/or handled via a database object such as a trigger or a constraint. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 505. Such instructions may be read into main memory 505 from another storage medium, such as storage device 510. Execution of the sequences of instructions contained in main memory 505 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 505. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire, and fiber optics, including the wires that comprise bus 502. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for biometric identification comprising:
a processor;
a memory attached to the processor; and
a computer readable medium having instruction embedded therein, the instructions configured to cause the processor to perform the operations of:
creating a user profile for an online account for a first user, wherein the user profile comprises a picture of a first user's face;
receiving a request from a second user requesting to verify the picture of the first user as being an authentic representation of the first user's face;
presenting through a computing device instructions of a specified pose for the first user to pose in a verification photo; and
submitting the verification photo of the first user with the specified pose to the second user for verification.

2. The system of claim 1, wherein the verification photo comprises a head shot of the first user.

3. The system of claim 1, wherein the verification photo comprises a body shot of the first user.

4. The system of claim 1, wherein the verification photo is in a graphic interchange format file.

5. The system of claim 1, wherein the specified pose comprises at least one of a hand gesture, facial expression, and body motion.

6. The system of claim 1, further comprising comparing the facial features of the first user's profile picture to a person in the verification photo.

7. The system of claim 1, further comprising verifying the pose of the verification photo as satisfying the pose instructions.

8. The system of claim 6, wherein the facial features are first user's profile picture is compared and analyzed to the verification photo using a facial recognition software.

9. The system of claim 7, wherein the pose of the verification photo is compared and analyzed to the pose instructions using a gesture recognition software.

10. The system of claim 1, wherein the second user determines whether the first user in the verification photo matches a person as indicated in the picture of the user's profile.

11. The system of claim 10, wherein the second user verifies the first user's profile when the verification photo satisfies the specified pose as instructed.

12. The system of claim 11, wherein the second user verifies the first user's profile when the verification photo accurately represents a person as presented in the picture of the user's profile.

13. The system of claim 1, further comprising generating a profile rating score, wherein a higher profile rating score is generated when the second user verifies the first user's profile.

14. The system of claim 1, wherein the second user is associated with an institution comprising at least one of banks, schools, social media companies, and retailers.

15. The system of claim 14, wherein the institution allows the first user access to the online account only after the verification photo is validated by the institution.

16. A method for real-time biometric identification comprising:
creating a user profile for an online account for a first user, wherein the user profile comprises a picture of a first user's face;
receiving a request from a second user requesting to verify the picture of the first user as being an authentic representation of the first user's face;
receiving instructions of a specified pose for the first user to pose in a verification photo; and
submitting the verification photo of the first user posing as instructed to the second user for verification.

17. The method of claim 16, wherein submitting the verification photo must be performed within a set time frame to ensure real-time verification of the first user.

18. The method of claim 16, wherein the second user validates the first user's profile when the verification photo satisfies the specified pose as instructed and also verifies that a person in the verification photo is the same person as presented in the picture of the user's profile.

19. The method of claim 16, further comprising generating a profile rating score, wherein a higher profile rating score is generated when other users validates the first user's profile.

20. The method of claim 16, wherein the second user is associated with an institution and the first user is only granted access to the online account after the institution validates the verification photo.
